(19) United States
(12) Patent Application Publication
(10) Pub. No.: US 2010/0032322 A1
(43) Pub. Date: Feb. 11, 2010

(54) Artist's disposable paint palette

(76) Inventor: Hugh O'Neill, Palm Beach Gardens, FL (US)

Correspondence Address: MCHALE & SLAVIN, P.A., 2855 PGA BLVD, PALM BEACH GARDENS, FL, 33410, US

(21) Appl. No.: 12/186,938

(22) Filed: Aug. 6, 2008

(51) Int. Cl. B44D 3/02; B44D 3/00

(52) U.S. Cl. 206/1.9; 206/1.7

(57) ABSTRACT

An artist palette kit consisting of a reusable storage container, a foldable support palette, and a plurality of disposable palette sheets. The backing support is preferably made of single piece of 16 inch by 12 inch paperboard having a centrally disposed living hinge that allows the backing support to fold onto itself forming a palette shaped support that can be held in one hand. The palette sheets are constructed of aluminum foil, or a paper material that is impregnated with foil, to allow a fixed configuration when folded. The foil has a matte finish and is used by the artist for placing of paints thereon while painting. The foil palette sheet allows for ease of disposal of paint by carefully folding the foil onto itself so that no leakage occurs before discarding. Alternatively the foil palette sheet further allows for ease of disposal of paint by carefully folding the foil onto itself and placing the paint into a chilled area for later reuse.

### FIELD OF THE INVENTION

This invention relates to the field of artist painting and, in particular, to a disposable artist paint palette kit.

### BACKGROUND OF THE INVENTION

A palette is commonly used by an artist for holding a multitude of paints. The palette allows the artist ease of access to the paints as well as providing an area to mix various paints to create blended color. Palettes are typically constructed of a rigid material shaped to allow ease of holding, such as with a thumb hole, which allows an artist to hold the palette in one hand while painting with the other hand. Various artists palettes used over the years consist of rectangular, circular, or a combination thereof and may include cup-shaped indentation for storing different colors. By having a various colors available to the artist, the artist can quickly apply paint to a canvas or other medium as well as mix a variety of the paints to come up with a unique color for a particular item being painted.

Palettes made of glass, metal or rigid non-porous plastic may be reused indefinitely. However, the cost of a reusable palette is typically very expensive and the surface must be capable of cleaning or risk early destruction if the paint is allowed to dry. Early drying is issue when the artist is painting outside a studio, such as field work. In such an instance, access to materials capable of rinsing the palette may not be possible and could entice an artist to cause pollution if it is known that the palette would be ruined if the paint is not removed before, causing such palettes to be rinsed in a drinking fountain, restrooms, or even a stream. In such instances, it is more appropriate to have a disposable palette and a means to prevent the disposed palette from leaking so as to entice the artist to dispose of the palette properly.

Conventional palette pads consist of a number of paper sheets attached to a cardboard backing support. Each paper sheet adds to the rigidity of the backing support and as each sheet is used and discarded, lessens the rigidity of the support. To maintain stability and a workable area in conventional pads, the individual sheets of palette paper rely and depend solely on the pad, with its rigid section, all being attached to each other to allow paper sheets to function properly as a suitable stable mixing surface. Conventional disposable palette pads typically have a semi-rigid cardboard backing support where all the paper sheets are glued and bound as one entity at a number of points. When in use, especially over constant use, spill and drips from water, oil based paints, mediums used for mixing and so forth can run over the sides onto and underneath the cardboard backing support. As a result the rigid board can be come soft. The pad surface can further develop uneven bumps as moisture-laden cardboard expands and contracts. Further, if used outdoors and in windy weather, the rain or dampness contacting the conventional paper palette pads can quickly render the entire pad unusable.

It should also be noted that conventional paper palettes can prove most difficult, if not impossible, to work with under certain weather conditions. In conventional paper palette pads, the paper has designated areas that are not glued or bonded permanently. This allows the user to extract used individual sheets however, this non-bonded section or paper, when exposed to wind, can cause the individual sheet to flutter causing an artist problems in maintaining the right paint amount on the brush. The windy or wet outdoor situation, the artist may resort to using a traditionally heavier palette or even a wooden palette. The paper palette sheet with paint can actually blow onto the users body parts when the paper based sheet pads are handheld. The user must then be most vigilant, and thus distracted that the paper remain stationary and bonded with the other sheets onto a rigid receiving surface. To maintain the stability in a workable area, the individual sheets of palette paper rely and depend solely on the pad, with its rigid section, all being attached to each other to allow paper sheets to function properly as a suitable mixing surface.

U.S. Pat. No. 3,856,136, “Disposable Palette” includes individual sheets of palette paper mounted together to form a book. Each sheet of palette is imprinted with marked sections, each such section being labeled with the name of a color and with the colors of each of several groups linked together. No material selection is contemplated for the sheets.

U.S. Pat. No. 3,945,490, “Covered Artist Palette Apparatus” provides an easily held artist palette which contains a pad of disposable sheets of material carried thereon for mixing the paints upon. The palette has a removable cover which holds the palette pad in place. No material selection is contemplated for the sheets.

U.S. Pat. No. 4,740,014, “Palette with Disposable Mixing Surface for Mixing Blendable Materials” includes a base, having a stabilizing apparatus, such as a thumb hole, and a pad of disposable mixing sheets secured to the base. Each of the disposable mixing sheets is releasably bonded to the other sheets. To allow the sheets to be separated from the pad after use, an unbounded portion of the perimeter of the pad is provided whereby the user may grasp and lift the sheets. Each sheet composed of a non-porous material.

U.S. Pat. No. 3,428,167 discloses an artist's palette assembly formed of a tapered self-supporting palette plate having a correspondingly tapered enveloping sheath tightly fitted thereon. A brush holder and a combination spring-release handle and sheath gripping element is attached thereto.

U.S. Pat. No. 3,732,972 discloses a wet palette comprising a flat base integral with a peripheral wall, with a portion of the wall extending over a portion of the base to form a parallel overhang. A water retentive pad is disposed across the base and beneath the overhang having a plurality of pigment containers seated in the overhang and in the openings in the pad. A water-permeable sheet overlies the pad and overhang, surrounding the pigment containers, and providing an area on which selected pigments may be placed and mixed. A flexible sleeve is used to encase the palette when not in use, to prevent dehydration.

U.S. Pat. No. 3,804,030 discloses a palette comprising a flat base preferably integral with a peripheral wall, with a portion of the wall extending over a portion of the base to form a parallel overhang. A water retentive pad is disposed across the base and beneath the overhang. A plurality of pigment containers are seated in the overhang and fit into openings in the pad. A water-permeable sheet overlies the pad and overhang, surrounding the pigment containers, and providing an area on which selected pigments may be placed and mixed.

U.S. Pat. No. 5,249,667 discloses an artist's palette having surface roughness values conducive to wetting, spreading and suspension maintenance of pigment media. Porous materials having selected permeability versus open porosity are disclosed for use as a palette substrate as well as a color pot in a reservoir system module Interchangeable color pots receivable in modules which in turn are receivable in work boxes are disclosed.

U.S. Pat. No. 4,858,955 discloses a palette for providing a surface upon which a user can mix materials with a mixing instrument. The palette includes a base which is a substantially rectangular planar member. To allow the palette to be steadily held during use, a stabilizing apparatus is provided which includes two thumb holes and a cut-out defined by the base. To receive the materials to be blended, a pad of disposable mixing sheets is secured to the base each being releasably bonded to the other sheets. To allow the sheets to be separated from the pad after use, a finger hole is defined by the base proximate an unbonded portion of the pad whereby the user may grasp and lift the sheets. A clip is provided for securing a mixing instrument to the base of the palette when such instrument is not in use.

U.S. Pat. No. 6,619,474 discloses a paint and palette caddy in the form of a case, which includes a hinged top with closures and a pull out drawer. Under the top is a rack having a number of sockets for holding paint cups by friction or indexing means and a number of slots for holding the paint cup caps. The upper area of the paint cups are slightly larger in dimension than the sockets; the drawer, when extended, provides a paint palette surface that may be covered with a disposable sheet so that the palette surface remains free from paint; the removable cups are sealed with an appropriate cap to provide an airtight seal between the surface of the paint and the cap; the cups may be removed from the case and stored in a freezer to preserve the paint for extended periods.

Thus, what is lacking in the art is a kit having a disposable backing support and palette sheets that can be attached to the backing support without tape, clips, or any other type of attachment mechanism.

### SUMMARY OF THE INVENTION

Disclosed is an artist palette kit consisting of a storage container, a foldable backing support, and a plurality of disposable palette sheets capable of maintaining a fixed configuration. The backing support is preferably made of single piece of 16 inch by 12 inch paperboard or plastic, having a centrally disposed living hinge that allows the backing support to fold onto itself forming a palette shaped support that can be held in one hand. One of the disposable palette sheets is then placed over the palette, the palette sheet formed from a material such as aluminum foil that maintains a fixed shape. The foil has a matte finish and is wrapped around the palette backing support and can is used by the artist for placing of paints thereon while painting. The foil palette sheet allows for ease of disposal of paint by carefully folding the foil onto itself so that no leakage occurs before discarding. Alternatively the foil palette sheet further allows for ease of disposal of paint by carefully folding the foil onto itself and placing the paint into a chilled area; reuse simply requires the foil to be unfolded and placed over the palette backing support.

An objective of the invention is to disclose the use of a low cost painting kit that provides separate palette sheets to eliminate the possibility of paint spillage from spoiling unused palette sheets and/or a backing board.

Yet another objective of the invention is to disclose the use of disposable palette sheets that are formed from a foldable material, such as aluminum foil, capable of retaining a folded state.

Still another objective of the invention is to disclose a non-porous palette sheet that can protect paper board backing supports from water based paints, oil based paints, mediums used for mixing, rain, dampness and so forth.

Still another objective of the invention is to disclose a palette kit that allows the artist to carry only the number of palette sheets necessary, versus the full volume of a complete traditional paper based disposable palette pad, while maintaining the rigid support palette.

Another objective of the invention is to eliminate the need for separate attaching items, such as tape, for use in securing a disposable palette sheet to a palette support plate.

Still another objective of the invention is to disclose a disposable palette sheet that can be compressed into a minimal volume to reduce waste size.

Another objective of the invention is to disclose a foldable support palette that is maintained in a folded position by use of a disposable palette sheets.

Still another objective of the invention is to disclose a palette sheet that can be used with paints in various states of fluidity. Artists are known to use paints with various mediums such as quick drying agents creating a “stickiness” that can render conventional disposable paper palette unusable as the paper lifts with the modified paint. Artists may also use brushes that have strong fibers for oil or acrylics paints and/or use up to 14 colors where again the lightweight paper palette sheets can be easily lifted. The palette sheet of the instant invention allowing the artist to use any type and/or thickness of paint without causing the detachment of the palette sheet from the palette support.

Other objectives and advantages of this invention will become apparent from the following description taken in conjunction with the accompanying drawings wherein are set forth, by way of illustration and example, certain embodiments of this invention. The drawings constitute a part of this specification and include exemplary embodiments of the present invention and illustrate various objects and features thereof.

### BRIEF DESCRIPTION OF THE DRAWINGS

FIG. 1 depicts the palette kit of the instant invention illustrating a storage container, a foldable backing support, and plurality of disposable palette sheets;

FIG. 2 is a perspective view of a backing support in a partially folded position;

FIG. 3 is a perspective view of a palette sheet in a folded position forming a palette support that can be held in one hand;

FIG. 4 is a folded backing support with a disposable palette sheet ready for attachment;

FIG. 5 shows the rear view of a palette support having a palette sheet secured thereto; and

FIG. 6 depicts a palette support with the palette sheet placed thereon with pictorial of various paints placed on the palette sheet as held by an individual.

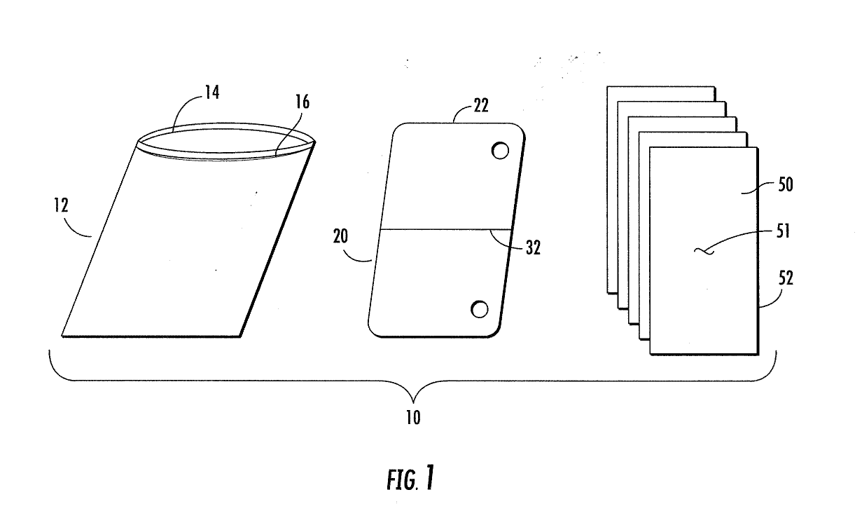

### DETAILED DESCRIPTION OF THE PREFERRED EMBODIMENT

Referring to the figures, depicted is the artist palette kit of the instant invention (10) consisting of a storage container (12), palette support plate (20) and disposable palette sheets (50). The storage container may resemble an envelope having an open end (14) with an inner cavity available for insertion and storage of the palette support plate and disposable sheets. The preferred embodiment of the storage container is to include a seal (16) so as to prevent items placed therein from falling out. The seal may be an envelope flap, Velcro, Ziploc, or a string with posts, any of which allow the storage container (12) to be reused. A palette support plate (20) is stored within the storage container is defined by a front surface (22), a rear surface (24) bonded by a continuous side edge (26). The backing support has a top end (28) and a bottom end (30) separated by a living hinge (32). The living hinge equally dividing the support plate into an upper section (34) and a lower section (36). The upper section (34) is foldable onto the lower section (36) by use of the living hinge (32) so as to align the upper edge (28) to the lower edge (30).

The backing support is preferably constructed of paper board which allows for low cost in manufacturing and disposability through recycling. Alternatively, the backing support may be made from a more rigid material such as plastic, either of which may be created from a thinner material as thickness is provided upon the folding of the upper section to the lower section effectively doubling the thickness of the backing support. In addition, a first thumbhole (40) may be placed along the upper section (34) and a second thumbhole (42) may be placed along the lower section (36). When the backing support is folded into the palette support shape, thumbholes (40 and 42) are aligned and an individual may support the palette in its conventional manner by placing their thumb through the holes and using the rest of their fingers as the rear support.

The palette sheets (50) are made of a material that maintains its shape when folded. The preferred embodiment is a palette sheet formed from aluminum foil having a thickness less than 0.005 inches or a paper impregnated with foil. The foil is coated with a non-reflective, non-porous matte finish which is neutral in color such as off-white, light grey, or the like. The porous matter helps to prevent very fluid paints from sliding off the foil as well as eliminating glare when the palette sheet is used in the bright outdoors. In addition, the matte may include indicia thereon to help an artist position the various paints used in the process. The aluminum foil is impervious to seepage of water based and oil based paints and maintains a folded position when placed around the palette.

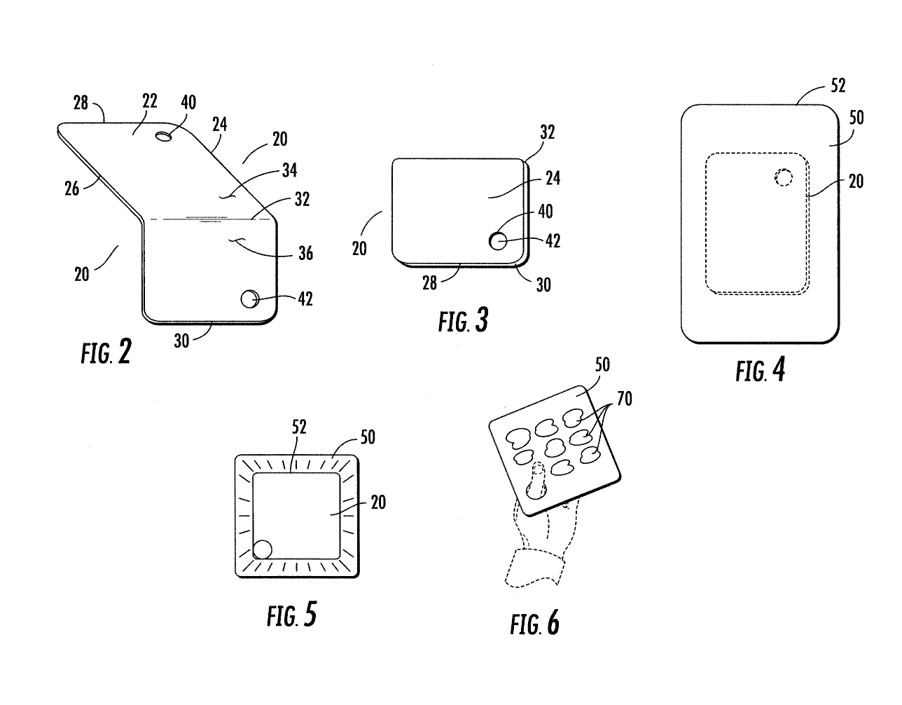

FIG. 4 depicts the palette support (20) in a folded position with a new foil palette sheet (50) positioned over the palette support and ready for folding. The folded palette support, reduced in size from 16 inches by 12 inches is now sized as 8 inches by 12 inches. The folded palette support is configured to fit within the foil which is preferably 16 inches by 12 inches; the foil encompassing the surface of the palette support and all of the exposed side edges. As shown in FIG. 5 the palette support (20) is depicted with the foil palette sheet wrapped around the support with the edge (52) of the foil folded in such a position so as to prevent the upper and lower sections (34 and 36) from unfolding thereby creating a stable platform without the need for additional securement. It should be noted that by folding of the palette support the thickness of the support is doubled thereby allowing a thinner material to be used. In addition, when paper board is employed, the foil prevents paint and/or other moisture from contacting the edge of the paper board which is the most susceptible to degradation when moisture is present. The edge of paper board providing an entry for moisture to cause delaminating. FIG. 6 depicts the palette sheet placed over the palette support for use by the artist wherein various paints (70) may be placed upon matte (51) in its ordinary and conventional manner.

The palette sheet having a foil base maintains its shape when in a folded position so as to prevent the palette sheet from blowing away which is typically an occurrence by an artist working in an outdoor, windy condition. In addition, the aluminum foil addresses problems that commonly occur with paper palettes which arise from sticky and drying paint. Artist are known to use drying retardant, water sprays, and the like to keep paint soft and pliable in order to mix and manipulate. Water, sprays and the like materials can quickly seep through the conventional paper sheet palette causing the backing support to become soft from moisture or even delaminate. Even a minor delaminating can result in bubbles leading to premature disposal of the backing support. The artist may further use a sealed container to store the palettes which may include a wet sponge to slow down the drying process. The use of a paper palette can quickly absorb that access moisture adding to the early degradation of the backing support. The use of the aluminum foil prevents such problems wherein the aluminum seals the edge of the backing support where the moisture must access in order to cause the aforementioned delaminating.

An artist may use other types of mediums to alter the state of the paint due to various conditions. For instance, quick drying agents are used for speeding the drying process in an aid increasing the weight of the paint and its stickiness to paper. However, such drying agents cause the paint to become sticky and the artist can quickly destroy a paper palette as the paint operates as a glue causing a paper palette to be pulled or torn from its mounting surface. The use of the palette sheet constructed of foil or foil impregnated material prevents the detachment of the palette sheet from the palette backing support even when the artist uses brushes that have strong fibers. The use of an impervious palette sheet is most beneficial for oil or acrylic paints which are known to cause paper palettes to become unstable. While the preferred size of the backing support is 16 inches by 12 inches, which is then folded into an 8 inch by 12 inch shape, it should be understood that the palette of the instant invention can be sized upward or downward without diminishing from the scope of this invention.

It is to be understood that while I have illustrated and described certain forms of my invention, it is not to be limited to the specific forms or arrangement of parts herein described and shown. It will be apparent to those skilled in the art that various changes may be made without departing from the scope of the invention and the invention is not to be considered limited to what is shown in the drawings and described in the specification.

1. An artist's palette kit comprising: a container; a backing support defined by a front surface and a rear surface bounded by a continuous side edge forming a full size artist palette, said backing support having a centrally disposed living hinge extending from a first point on said side edge to a second point on said edge forming an upper section and a lower section, said upper section foldable over said lower section along the living hinge forming a half size artist pallet and allowing ease of storage in said container; at least one foil palette sheet sized to cover said backing support and said continuous side edge, said foil palette sheet having sufficient impregnated aluminum to allow malleability for fastenless securement to said backing support;
wherein said backing support is removable from said container whereby one of said foil palette sheets is securable to said backing support by folding a portion of said foil palette sheet around said continuous side edge providing a disposable surface for artist paints, whereby said foil palette sheet is curled upon itself for containing the paints with the foil palette sheet to allow a leak free disposal.

2. The artist's palette kit according to claim 1 wherein said backing support is constructed from paperboard.

3. The artist's palette kit according to claim 1 wherein said backing support is constructed from plastic.

4. The artist's palette kit according to claim 1 wherein said backing support includes an aperture formed through said upper section and said lower section wherein folding said front surface of said upper section onto said front surface of said lower section aligns each said aperture forming a thumb hole for use in supporting the palette in the folded position, said foil palette sheet having sufficient malleability for maintaining said palette in the folded position.

5. (canceled)

6. The artist's palette kit according to claim 1 wherein each said palette sheet is formed from an aluminum foil having a thickness less than 0.005 inches.

7. The artist's palette kit according to claim 6 wherein one side surface of said aluminum foil sheet is coated with a non-reflective, non-porous matte.

8. The artist's palette kit according to claim 7 wherein said matte is neutral in color.

9. The artist's palette kit according to claim 7 wherein said matte includes indicia to indicate a designated mixing area.

10. The artist's palette kit according to claim 1 wherein each said palette sheet is sized to wrap around said front surface of said upper section of said backing support.

11. (canceled)
